(19) United States
(12) Patent Application Publication
(10) Pub. No.: US 2015/0176692 A1
(43) Pub. Date: Jun. 25, 2015

(54) SPROCKET

(71) Applicants: Hyundai Motor Company, Seoul (KR); Kia Motors Corporation, Seoul (KR)

(72) Inventor: Tae Hoon Roh, Seoul (KR)

(73) Assignees: Hyundai Motor Company, Seoul (KR); Kia Motors Corporation, Seoul (KR)

(21) Appl. No.: 14/304,714

(22) Filed: Jun. 13, 2014

(30) Foreign Application Priority Data
Dec. 20, 2013 (KR) 10-2013-0160724

(51) Int. Cl. F16H 55/30; F16H 7/06

(52) U.S. Cl. CPC F16H 55/30; F16H 7/06

(57) ABSTRACT

A sprocket may include a sprocket shoulder formed in a hollow cylindrical shape, a plurality of teeth uniformly protruded along an outer circumferential surface of the sprocket shoulder to fit in a chain, a plurality of grooves formed between adjacent teeth, and being engaged to and driven by the chain, and a rubber coating ring with a plurality of projections uniformly formed along an outer circumferential surface of both sides or one side of the teeth in an axial direction of the teeth.

### CROSS-REFERENCE TO RELATED APPLICATION

The present application claims priority of Korean Patent Application Number 10-2013-0160724 filed on Dec. 20, 2013, the entire contents of which application are incorporated herein for all purposes by this reference.

### BACKGROUND OF INVENTION

1. Field of Invention

The present invention relates to a sprocket, and more particularly, to a structure of a sprocket for reducing noise and vibration of a sprocket rotating in mesh with a chain.

2. Description of Related Art

A sprocket is a mechanical element that is fitted on a rotary shaft and transmits power by rotating in mesh with a chain. Power transmission by a chain is usually made between short shafts by a chain and a sprocket. It is also called a chain gear. It can fully transmit relatively large power without sliding, but vibration and noise are caused by friction or contact between the chain and the sprocket.

Chains that are engaged with sprockets usually include a chain plate and a chain bush. The chain plate is a flat member with both arc ends and the chain bush is a cylindrical member coupling two chain plates facing each other at its both ends. The coupling of a chain bush and chain plates are made such that the chain plates can rotate about the chain bush. Two chain plates and two chain bushes make one unit (joint) of a chain and a plurality of chain joints is connected by sharing one of two chain bushes. Both ends of a chain which longitudinally extend are connected in this way, thereby completing a chain.

A chain achieved in this way transmits power in mesh with the teeth of a sprocket. In general, the teeth of a sprocket are fitted in between chain bushes, the force driving a chain connected to a driving shaft is transmitted sequentially through chain plates and the chain bushes, and the chain bushes of the chain engaged with the sprocket on a driven shaft apply circumferential force to the teeth, so that the power is transmitted to the driven shaft.

The noise generated in power transmission by chains is usually regular metallic noise that is generated when chain bushes fit onto or come in contact with the teeth of sprockets. Chain bushes may cause vibration, in addition to noise, by hitting against the teeth or the grooves between the teeth of sprockets. The noise and vibration due to shock energy may travel into a vehicle through the vehicle body, so there is a need of measures.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a sprocket having advantages of reducing regular metallic noise and vibration that is generated when a chain is engaged with the sprocket.

In an aspect of the present invention, a sprocket may include a sprocket shoulder formed in a hollow cylindrical shape, a plurality of teeth uniformly protruded along an outer circumferential surface of the sprocket shoulder to fit in a chain, a plurality of grooves formed between adjacent teeth, and being engaged to and driven by the chain, and a rubber coating ring with a plurality of projections uniformly formed along an outer circumferential surface of both sides or one side of the teeth in an axial direction of the teeth.

The projections are formed to correspond to locations of the grooves.

The projections are formed such that plates of the chain come first in contact with the projections, right before chain bushes of the chain come in contact with the grooves.

The projections are formed in a semicircular shape.

The projections are made of rubber and coated on an outer circumferential surface of a hollow cylindrical rubber coating ring engaged to the sprocket shoulder or integrally formed with the rubber coating ring engaged to the sprocket shoulder.

The rubber coating ring is made of rubber the same as that of the projections.

The rubber coating ring is bonded to the outer circumferential surface of the sprocket shoulder, or to all of both sides or one side of the teeth, in the axial direction of the teeth and the outer circumferential surface of the sprocket shoulder.

As described above, according to exemplary embodiments of the present invention, it is possible to improve comfort in a vehicle by reducing vibration or noise that is generated when a chain is engaged with a sprocket.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view and a cross-sectional view illustrating a sprocket according to an exemplary embodiment of the present invention.

FIGS. 2A, 2B, and 2C are views illustrating an inter-operation mechanism of a chain and the sprocket according to an exemplary embodiment of the present invention.

FIG. 3 is a view illustrating the effect of the sprocket according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTIONS

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention will be described more fully hereinafter with reference to the accompanying drawings, in which exemplary embodiments of the invention are shown.

The exemplary embodiment is an example of the present invention and can be modified in various ways by those skilled in the art, so the scope of the present invention is not limited to the exemplary embodiment of the present invention to be described below.

Through the present specification, unless explicitly described otherwise, “including” any components will be understood to imply the inclusion of other components rather than the exclusion of any other components. Further, the names of the components do not limit their function.

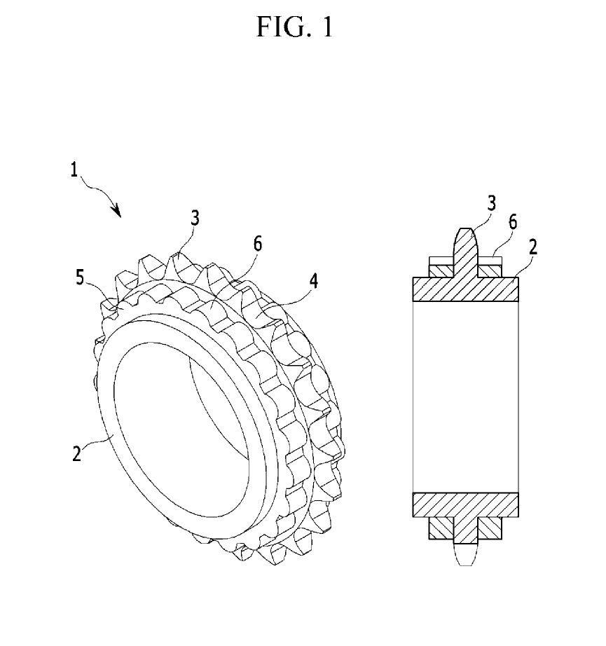

FIG. 1 is a perspective view and a cross-sectional view illustrating a sprocket according to an exemplary embodiment of the present invention.

Referring to FIG. 1, a sprocket 1 according to an exemplary embodiment of the present invention may have a sprocket shoulder 2, a plurality of teeth 3, a plurality of grooves 4, and a rubber coating ring 5.

The sprocket shoulder 2, a hollow cylindrical member, is fitted on a shaft.

The teeth 3, which are portions uniformly protruding along the outer circumferential surface of the sprocket shoulder 2 for transmitting power, are fitted in chain bushes 7 (see FIG. 1) of a chain.

The grooves 4, which are the portions formed between the adjacent teeth 3 and connecting them, are the lowest portions between the teeth 3.

The rubber coating ring 5 is a ring type member mounted both sides or one side in the axial direction of the teeth 3 and may have a plurality of projections 6 uniformly formed along the outer circumferential surface. The projections 6 may be formed by coating the rubber coating ring 5 with a rubber material. The rubber coating ring 5 and the projections 6 may be integrally made of the same rubber or only the projections 6 may be formed by coating. Only the projections 6, not the rubber coating ring 5, may be made of rubber.

The projections 6 may be formed to fit the grooves 4. Accordingly, the line connecting the center of the grooves 4 with the center of the circle traversing the sprocket 1 are be in parallel with the line connecting the center of the projection 6 with the center of the circle traversing the sprocket.

The projections 6 may be formed in semicircular shape. However, they are not limited thereto.

The rubber coating ring 5 may be bonded to the outer side of the sprocket shoulder 2 or may be bonded to both sides or one side in the axial direction of the teeth 3. When the rubber coating ring 5 is bonded to the outer side of the sprocket shoulder 2, the force of a chain is applied perpendicularly to the bonding side, so it is advantageous in bonding strength. The rubber coating ring 5 may be bonded to all of both sides or one side in the axial direction of the teeth 3 and the outer side of the sprocket shoulder 2.

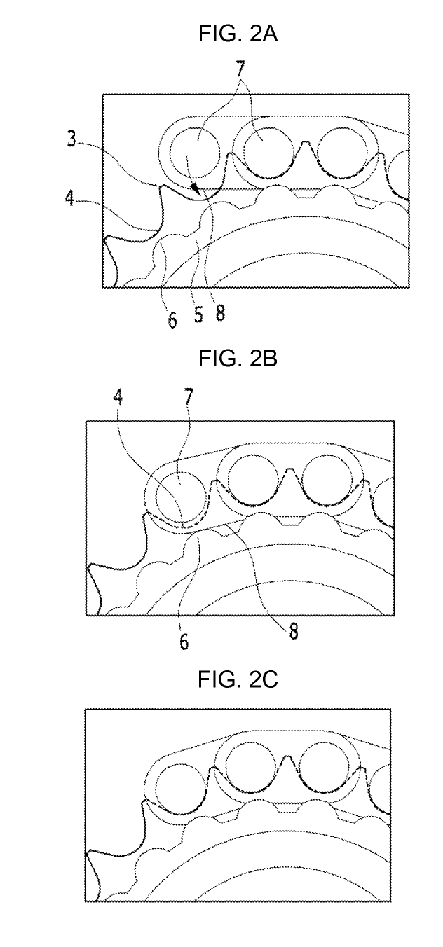

FIGS. 2A, 2B, and 2C are views illustrating an inter-operation mechanism of a chain and the sprocket according to an exemplary embodiment of the present invention.

FIG. 2A illustrates the sprocket 1 according to an exemplary embodiment of the present invention and chain bushes 7 and chain plates 8 of a chain, in which the chain bushes 7 is rotating toward the bottoms of the grooves 4. When the chain is engaged with the sprocket 1, the chain bushes 7 and the chain plates 8 move in the direction of the arrow.

FIG. 2B illustrates the state right before the chain bush 7 comes in contact with the bottom of the groove 4. As illustrated in FIG. 2B, the chain bush 7 are not yet in contact with the bottom (dotted line) of the groove 4. The bottom of the chain plate 8 comes first in contact with the projection 6 of the rubber coating ring 5. Since the projection is made of rubber in an exemplary embodiment of the present invention, the projection 6 can be compressed when the bottom of the chain plate 8 comes in contact with it. Accordingly, the projection may function as a kind of damper.

FIG. 2C illustrates that the chain plates 8 absorb some of shock energy that may be generated when the chain bushes 7 come in contact with the grooves 4 while compressing the semicircular projections. The shock energy is reduced by contact and compression between the chain plates 8 and the projections 6, so that noise and vibration can be reduced.

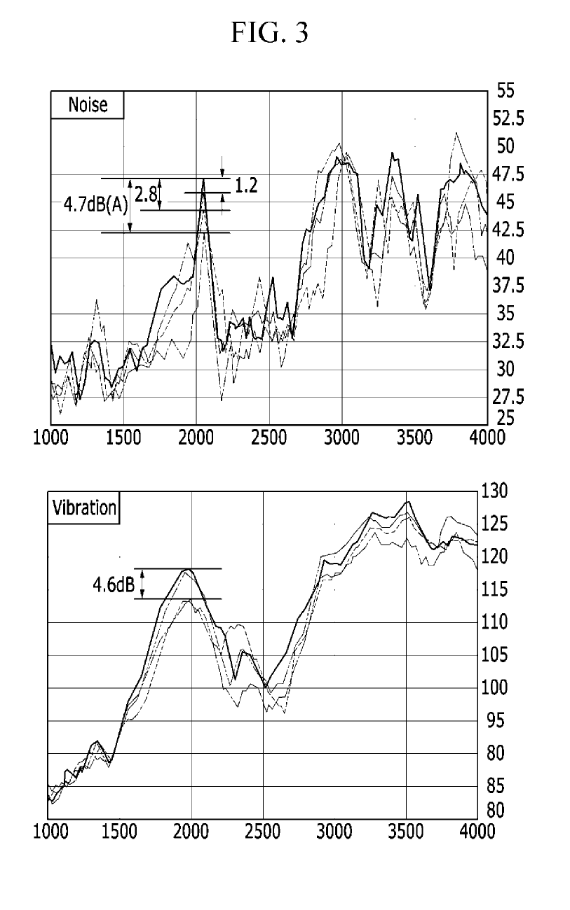

FIG. 3 is a view illustrating the effect of the sprocket according to an exemplary embodiment of the present invention.

Referring to FIG. 3, it can be seen that the peak value of noise reduces by 4.7 dB(A) and vibration reduces by 4.6 dB. This is the result of reducing vibration and noise by using the sprocket on a fuel pump of an R-engine.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A sprocket comprising:
a sprocket shoulder formed in a hollow cylindrical shape;
a plurality of teeth uniformly protruded along an outer circumferential surface of the sprocket shoulder to fit in a chain;
a plurality of grooves formed between adjacent teeth, and being engaged to and driven by the chain; and
a rubber coating ring with a plurality of projections uniformly formed along an outer circumferential surface of both sides or one side of the teeth in an axial direction of the teeth.

2. The sprocket of claim 1, wherein the projections are formed to correspond to locations of the grooves.

3. The sprocket of claim 1, wherein the projections are formed such that plates of the chain come first in contact with the projections, right before chain bushes of the chain come in contact with the grooves.

4. The sprocket of claim 3, wherein the projections are formed in a semicircular shape.

5. The sprocket of claim 3, wherein the projections are made of rubber and coated on an outer circumferential surface of a hollow cylindrical rubber coating ring engaged to the sprocket shoulder or integrally formed with the rubber coating ring engaged to the sprocket shoulder.

6. The sprocket of claim 5, wherein the rubber coating ring is made of rubber the same as that of the projections.

7. The sprocket of claim 1, wherein the rubber coating ring is bonded to the outer circumferential surface of the sprocket shoulder, or to all of both sides or one side of the teeth, in the axial direction of the teeth and the outer circumferential surface of the sprocket shoulder.
